(19) United States
(12) Patent Application Publication
(10) Pub. No.: US 2014/0136233 A1
(43) Pub. Date: May 15, 2014

(54) Managing Personal Health Record Information about Doctor-Patient Communication, Care interactions, health metrics ,customer vendor relationship management platforms, and personal health history in a GLOBAL PERSONAL HEALTH RECORD TIMELINE integrated within an (ERP/EMRSE) ENTERPRISE RESOURCE PLANNING ELECTRONIC MEDICAL RECORD SOFTWARE ENVIRONMENT localized medical data ecosystem

(71) Applicants: William Atkinson, Orlando, FL (US); Wayne Atkinson, Orlando, FL (US)

(72) Inventors: William Atkinson, Orlando, FL (US); Wayne Atkinson, Orlando, FL (US)

(21) Appl. No.: 13/676,939

(22) Filed: Nov. 14, 2012

(51) Int. Cl. G06F 19/00

(52) U.S. Cl. CPC G06F 19/3487
USPC 705/3

(57) ABSTRACT

The invention discloses a system, method and computer program for generating a Global Personal Health Record Timeline (GPHRT) is provided. A plurality of data items and information points associated with at least one relationship between users associated with a single patient, healthcare provider, a group of healthcare providers. Ordered data items are stored in a personal health record, transmitted and shared via a plurality of storage and transmittal technologies such as, (BLE), barcode scanner, and a plurality of other storage and transmittal technologies that will interface with the Global Personal Health Record Timeline platform. These aforementioned embodiments would further be integrated into an Enterprise Resource Planning Electronic Medical Records Software Environment (ERP/EMRSE) which would interface with a Database Repository with a web-based Global Patient Health Record Timeline interface portal, security interface, Customer Resource Management platform, Practice Management platform, e-commerce interface, “HIPPA” compliant security filter.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

This invention relates generally to an Enterprise Resource Planning Electronic Medical Record software environment focused on both clinical and practice supply chain management along with the management of Doctor-Patient Communications, Care interactions, healthcare metrics, customer vendor relationship management platforms, and a personal health history record represented in a chronological as well as graphical presentation within an fully integrated Enterprise Resource Planning environment focused and designed for both the medical and dental industry. This invention utilizes and integrates social networking, Electronic Medical Records, Global Patient Health Record Social network timeline to graphically and chronologically store patient health record data in a cloud based data repository. Further this invention utilizes (CRM) Customer Resource management/(PM) Practice Management software and (RFID) radio frequency identification technology along with (BLE) Bluetooth Low Energy technology in one complete Enterprise Resource Planning Electronic Medical Record software environment. More particularly, the invention relates to Reception Counter Management, Outpatient-Doctor relationship management, EMR, EMS Inpatient-Doctor relationship management, e Commerce along with vendor Management, Patient Billing and charge capture, Financial Metric Report generation, Marketing Program Management, Visiting Consultants, Medical supply and other Inventory management, Pathology Laboratory, Radiology Laboratory, Blood Bank, Diet, Financial Accounting, Payroll System with HR management services, Management Information System (MIS), social network integration, (RFID) Radio frequency Identification technology along with other technology such as (BLE) Bluetooth Low Energy technology capabilities.

### BACKGROUND OF THE INVENTION

The present invention relates generally to social networking, Health Information Exchange (HIE), Personal Health Records (PHR) and more particularly to systems and methods for integrating external data from a Health Information Exchange (HIE), Personal Health Record (PHR), Picture Archiving and Communications System (PACS), Hospital Information Systems (HIS), Laboratory Information Systems (LIS), Assigned Healthcare Providers, along with external data from a plurality of sources and integrating all of these data points with a social network system and a cloud or internet based aggregate repository network to generate a communication environment of interoperability between external data sources points that traditionally would never interface, but would interface and communicate to organize, distribute, and store healthcare record information in a chronologically ordered format within the Global Personal Health Record Timeline (GPHRT) platform. These aforementioned embodiments would further be integrated into an (ERP/EMRSE) or Enterprise Resource Planning Electronic Medical Records Software Environment which would interconnect an Network Aggregate Database Repository with a Cloud or web-based Global Patient Health Record Timeline interface portal, security interface, (CRM) customer resource management platform, Practice Management platform (PM) e-commerce interface, “HIPPA” compliant Security filter, and Radiofrequency Identification Technology (RFID) and Bluetooth Low Energy (BLE) Technology interface to connect beneficial users or patient to healthcare provider users and these users to external sources of medical and health records data. These aforementioned embodiments would further be integrated into an Enterprise Resource Planning Electronic Medical Records Software Environment (ERP/EMRSE) which would interconnect an Network Aggregate Database Repository with a Cloud or web-based Global Patient Health Record Timeline interface portal, security interface, (CRM) customer resource management and (PM) Practice management platform, e-commerce interface, “HIPPA” compliant Security filter, and Radiofrequency Identification Technology (RFID) and Bluetooth Low Energy (BLE) Technology interface to connect beneficial users or patient to healthcare provider users and further connect both of these users to external sources of medical and health records data related to the beneficial user or patient. Also the Enterprise Resource Planning Electronic Medical Records Software Environment (ERP/EMRSE) would generate more connectivity and efficiencies between healthcare providers and the third party source vendors that they interact. The Enterprise Resource Planning Electronic Medical Records Software Environment (ERP/EMRSE) would also allow more streamlined and seamless communication and data sharing from one healthcare entity to another healthcare entity within the Enterprise Resource Planning Electronic Medical Records Software Environment (ERP/EMRSE) Network to help improve customer care for patients, improved workflows, efficient e-Commerce management solutions, improved market research that does not violate “HIPPA” standards, increased security of information and improved resource procurement management solutions.

Conventionally, people have networked with one another by joining religious organizations, civic organizations, social clubs, attending sporting events in designated groups, meeting peers through other friends and co-workers and so forth. The revolution of the internet and social network based media and their power to create a global community where people of various walks of life from various parts of the globe can meet and communicate in real time has removed barriers that once presented challenges for people meeting and sharing information, common interest, and identifying as well as establishing a cultural exchange of information that has become a global phenomenon.

For many people, especially within the healthcare industry, the internet, social networking systems, Electronic Medical Records, Personal Health Records and Health information Exchanges represent the principle way in which patients and providers will soon meet and exchange information that will generate more collaborative and more productive Doctor-Patient treatment outcomes. In addition to directing more efficient Doctor-Patient treatment outcomes, the merging of the internet, social networking systems, Electronic Medical Records and Health Information Exchanges will create a new framework and medium of information exchange and communication between providers, patients and other members of the health care team. Currently methods of cataloging and organizing Electronic medical records among healthcare providers and facilities, such as hospitals, group practices, private solo practices, various medical metric devices, and outpatient ambulatory facilities is highly fragmented. This fragmented organization of data introduces multiple inefficiencies among providers, among health care organizations and ultimately aggregate inefficiencies and frequent breakdowns in effective communication within the Healthcare Industry as a whole.

In order to introduce seamless continuity of care and improved communication across the healthcare industry, the development of an improved tapestry of communication, secured health care records storage systems and resource management systems will have to be created, fostered and advocated by all participants in the Healthcare Industry.

### BRIEF SUMMARY OF THE INVENTION

The present invention provides a system and method for generating a Patient Health Record Social Timeline that integrates external medical records data from a plurality of external sources and integrates the data into a Global Personal Health Record Social Timeline. The integrated data items are associated with at least one relationship between users associated within a Patient Health Record Social Network Timeline, each data item having a chronological ordered and associated time. The data items are ordered according to at least one relationship.

A Global Patient Health Record Social Timeline is ordered according to the integration of both data items from external and internal data sources to generate a chronological patient health record social network timeline. Further the chronological cataloging of the patient health record within a patient health record social network is also enabled to transmit, store and acquire data from the global patient health record social timeline platform to a plurality of external articles of manufacture through the utilization of Radio Frequency Identification Technology (RFID) and Bluetooth Low Energy technology (BLE); In addition to a plurality of other alternate methods of data acquisition, transmittal, and storage along with a user security interface function that is operated via “HIPPA” or “Health Insurance Portability and Accountability Act” compliant explicit authorization encrypted password filter security interfaces.

These aforementioned embodiments would further be integrated into, an (ERP/EMRSE) or Enterprise Resource Planning Electronic Medical Records Software Environment which would interconnect an Network Aggregate Database Repository with a Cloud or web-based Global Patient Health Record Timeline interface portal, security interface, Customer Resource Management (CRM) platform, Practice Management platform (PM), e-commerce interface, “HIPPA” compliant Security filter and Radiofrequency Identification (RFID) Technology and Bluetooth Low Energy (BLE) Technology interface to connect beneficial users or patient to healthcare provider users and these users to external sources of medical and health records data such as external Electronic Medical Record (EMR) system, Health Information Exchange (HIE) system, Personal Health Record (PHR) system, Picture Archiving and Communication System (PACS), Hospital Information Systems (HIS), Laboratory Information Systems (LIS), along with other Assigned Healthcare Providers.

In addition to connectivity between beneficial users or patients and healthcare provider users, the ERP/EMRSE will provide increased efficiencies and interconnectivity between individual healthcare providers, healthcare providers within a healthcare organization, hospitals, and outpatient facilities to connect with third party medical vendors and service companies along with interconnectivity between various healthcare entities within the ERP/EMRSE network.

### BRIEF DESCRIPTION OF THE SEVERAL VIEWS OF THE DRAWING

FIG. 1. Is a block diagram of an exemplary environment for generating a Global Personal Health Record Timeline.

FIG. 2. An exemplary illustration of a Global Personal Health Record Timeline network engine;

FIG. 3. Is a flow diagram of an exemplary process for ordering data for a Global Patient Health Record Timeline.

FIG. 4. Is a flow diagram of an exemplary process for generating a Global Patient Health Record Timeline

FIG. 5. Illustrates an exemplary embodiments of an ERP/EMRSE or ERP/EMR Software Environment or (Enterprise Resource Planning Electronic Medical Records Software Environment) that includes the Global Patient Health Record Timeline as a central component of the environment.

### DETAILED DESCRIPTION OF THE INVENTION

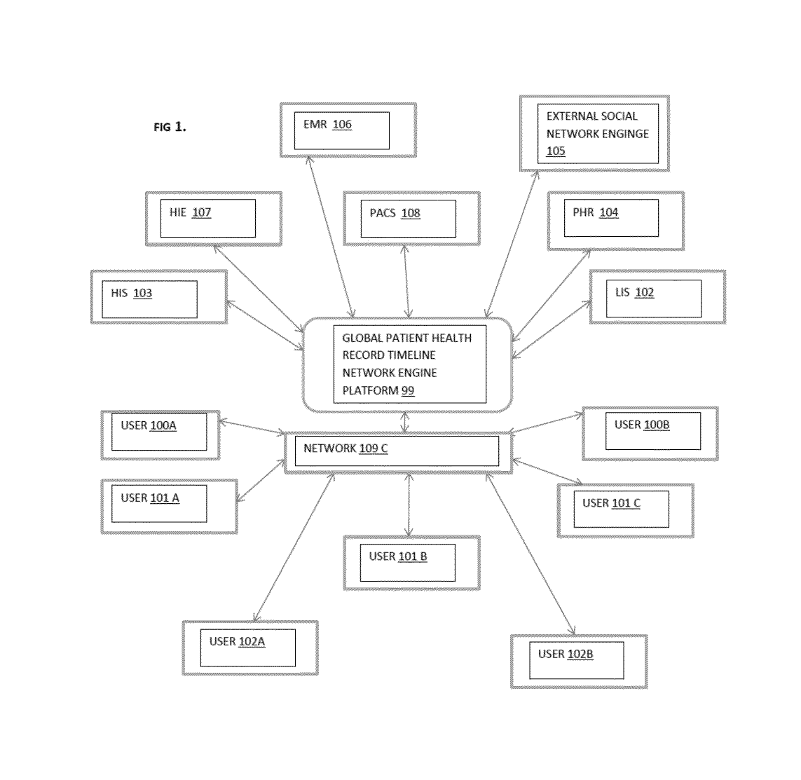

FIG. 1. Is a block diagram of an exemplary environment for generating Global Personal Health Record Timeline network engine platform. One or more users 101A, 101B, 100B, 101C, 102B, 101A and a beneficial user 109A or patient, are in communication with a Global Personal Health Record Timeline engine 99 via a network 109C. The Global Personal Health Record Timeline network engine 99 may consist of a social networking website, one or more servers operating the social networking website, Internal electronic medical record interface platform, Encrypted Security interface, HL7 Module interface, DICOM interface module, PAN-IF or Personal Area Network interface, Network Aggregate Repository Module, RFID interface module, Bluetooth Low Energy (BLE) technology, or any other device or application capable of providing the transmittal, storage, and transfer of information to and from Global Personal Health Record Timeline platform via the network 109C. The users 101A, 101B, 100B, 101C, 102B and 101A, can access services provided by the Global Patient Health Record Timeline Engine Platform via the network 109C and transport, storage, and transmittal of the same information originating from the Global Patient Health Record Timeline via Radio Frequency Identification (RFID) technology and other methods of transport, storage, and transmittal to a plurality of external devices and external articles of manufacture.

The users 101A, 101B, 100B, 101C, 102B and 101A may use a computing device, such as a handheld portable computing tablet, laptop or desktop computer, a cellular telephone, a Personal Digital Assistant (PDA), a set top box, RFID enabled bracelets, Bluetooth Low Energy (BLE) enabled bracelets, RFID enabled necklace, RFID enabled card, RFID enabled subcutaneous chip, Bluetooth Low Energy (BLE) enabled cellular phone, RFID enabled cellular phone, Bluetooth Low Energy (BLE) enabled tablet, RFID enabled tablet, along with a plurality of other articles of manufacture to access the Global Personal Health Record Timeline engine platform 99. The users 101A, 101B, 100B, 101C, 102B and 101A can view clinical data, patient records, lab and test values, treatment data, instant messaging and SMS messaging format from provider to provider and from provider to patient or beneficial user 109A as well as patient or beneficial user 109A to provider, view data about social network groups and network groups of providers, view patient health record social timeline of treatment encounters, join social network group forums of patients and providers with similar interest, users can also enter data about themselves and possibly others, and users can have access to various patient education data points and algorithms that generate lifestyle modification, dietary modification, and healthcare modification suggestions as well as monitoring functions to users 101A, 101B, 100B, 101C,102B and 101A. The users 101A, 101B, 100B, 101C, 102B and 101A are typically patients, physicians, nurses, physician assistants, and other health care providers that typically have access to and control of a plurality external health care record data sources that originate externally that are ordered and arranged in a sequential and chronologically order and further where patient users and medical provider users can communicate, and where medical providers users can communicate with other medical provider users through a Global patient health record timeline engine platform 99.

According to exemplary embodiments, a user 100A, identifies one or more other members associated with the Global patient health record timeline network engine platform 99, inclusive of a social network engine, and the network interface 109C, such as users 101C, 101B, and 102B, with which user 100A wants to build a relationship or distribute approved medical data related to the beneficial user 109A of the timeline or alter the details of an existing relationship or import supporting medical information from a plurality of external sources such as Health Information Exchange (HIE) system, Electronic Medical Records (EMR) system, Personal Health Records (PHR) systems, Picture Archiving and Communication System (PACS), Assigned Healthcare Providers, Hospital Information Systems (HIS), Laboratory Information Systems (LIS), and a plurality of other external health record data storage source points, that are related to the beneficial user 109A medical record, plan of treatment, existing contraindications, and medical history and these data points are shared with other medical providers, in this exemplary embodiment these could be represented by users 101C, 101B and 102B that have been pre approved by the beneficial user 109A and granted access in a manner that is compliant with current government HIPPA mandates. Utilizing both the Global Patient Health Record Timeline Platform 99 and inclusive social network and user interaction with both via Network 109C, the users 101C, 101B and 102B enters details about the provider and clinical relationship, medical records, plan of treatment and other data applicable and related to treatment of the beneficial user 109A. The Global Patient Health Record Timeline platforms and inclusive social networking module 99, then sends data comprising the details from users 101C,101B, and 102B to other users or medical providers, (i.e. 100A, 101A, 102A, and 100B) that are approved to access the Global Personal Health Record timeline of the beneficial user 109A by the beneficial users 109A initial grant of access to all subsequent users and or providers that are related to the beneficial users current medical care or have been involved in their care in the past. Upon receiving the data from users 101C, 101B and 102B and the users 100A, 101A, 102A and 100B may provide input in response to the data that is presented. The response may, for example, modify the existing data or enter new data.

The relationship with users 101C, 101B, and 102B as well as the beneficial user 109A or patient and users 100A, 101A, 102A, and 100B may confirmed, based on the input, by the Global patient health record timeline network engine platform 99. Conversely, the existence of the relationship may be denied, according to some embodiments. Any type of confirmation and/or input may be utilized to alter, deny, and/or establish the relationship between the beneficial user or patient 109A and the users 101C,101B, and 102B. Any type of confirmation and/or input be may be utilized in alter, deny, and/or establish the relationship between the beneficial user or patient 109A and the other users of the platform such as 101C, 101B, 102B or users 100A, 101A, 102A and 100B.

The relationship may comprise any type of relationship that exists between any two users within the platform and related directly to the personal health records of the beneficial user or patient 109A. For example user 101C may be a radiologist and user 101B may be the primary care physician for the beneficial user or patient 109 A, and the radiologist 101C may need to share final radiographic or MRI results and reports with user 101B or the primary care physician for the beneficial user or patient 109A. More than one relationship may exist between the two users. For example user 101C and user 101B may be members of the same group practice of physicians, and also share the same patients in common due to the comprehensive multidiscipline model of care that the group that they are members of chooses to utilize in patient care.

The data may then be ordered and arranged chronologically. For example the beneficial user or patient 109A may specify that the relationship with healthcare provider user 1016 the primary care physician is an older than the relationship with healthcare provider user 101C, the radiologist. In other words, the beneficial user or patient 109A can enter detailed data that indicates calendar dates, years, and other timing or time stamp data about the relationship. The Global Patient Health Record Timeline Network engine platform 99 can then order and organize the entered data by the indicated times and generate a patient health record timeline based on the ordered data. The Global Patient Health Record Timeline indicates when certain events related to the relationships occurred, for example, such as in the year 2001, Mar. 16, the beneficial user or patient 109A, received an immunization update and allergy vaccinations from 101B, the primary care physician of the beneficial user 109A. Another example would be if the beneficial user or patient 109A in the year 2002, May 10 had a back surgery performed by healthcare provider 100A, an orthopedic surgeon and subspecialist, and after surgery the beneficial user 109A had specific complications that would be noted and listed. The event encounter data from both healthcare provider users 1016 and 100A would then be entered and the data would be ordered in a chronological order within the Global Patient Health Record Timeline Network engine platform 99 and it would generate a Global Patient Health Record Timeline in an ordered and chronological way. It also would create the opportunity for social networking interaction, sharing of medical test such as lab results and X rays in real time and other supporting medical data from a variety of external sources. It would also allow SMS messaging interaction regarding the beneficial user or patient 109A between provider 1016 and 100A, only if the beneficial user or patient 109A has granted security clearance and access to the Global Patient Health Record Timeline to both healthcare provider users 1016 and 100A.

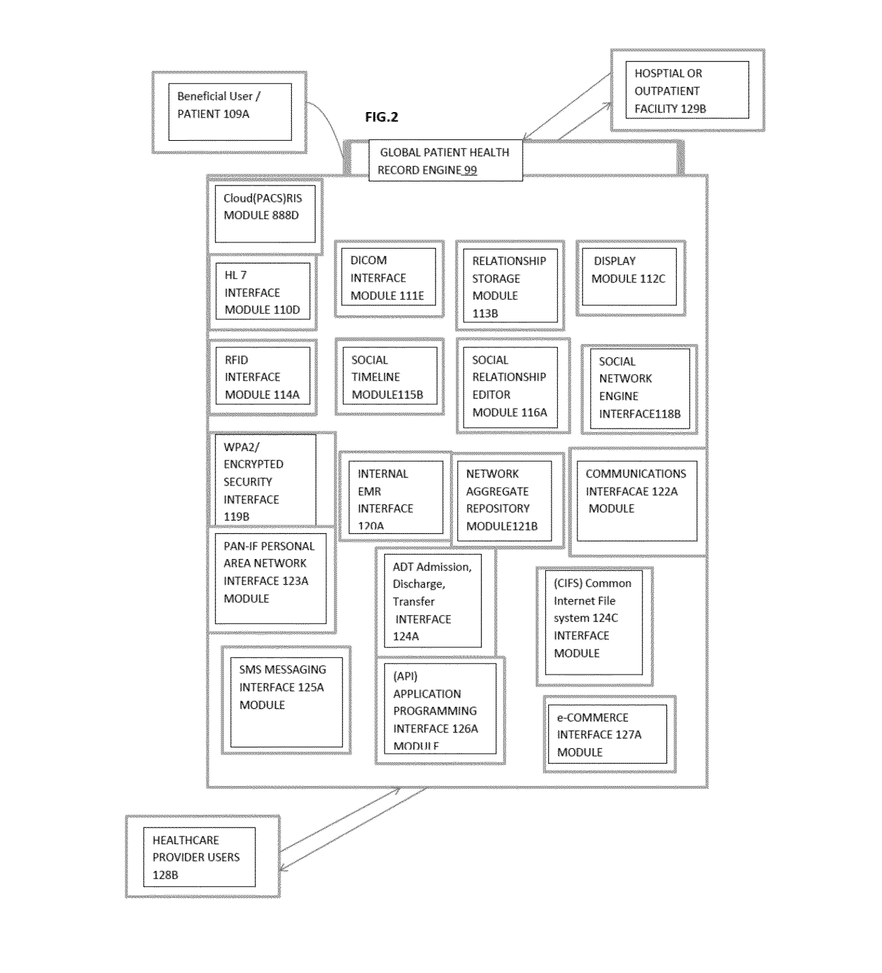

Referring to FIG. 2. An exemplary Global Patient Health Record Timeline Network engine 99 is illustrated with the necessary components and embodiments. The principle components and interfaces of the Global Patient Health Record Timeline are: A communication interface 122A, which is present in conjunction with a Social Network Engine interface 118B to send and receive data between the beneficial user or patient 109A and the healthcare provider users 128B that are currently providing care to the beneficial user 109A or have provider care to the beneficial user or patient in the past. The users can send relevant data to the Global Patient Health Record Timeline platform 99 and modify details about relationships, events, health records, and plurality of other functions and utilize these functions to generate a timeline with relevant details related to the Beneficial user 109A or patient's personal health record based on data entered into the Global Patient Health Record Timeline Network engine platform 99 format.

Typically the beneficial users or patients 109A along with approved security access clearance approved healthcare provider users, granted by the beneficial user 109A at some point in the past, would access a dual portal cloud or website based Electronic Medical Records Global Patient Health Record Timeline platform 99 via an encrypted security interface 119A, and a communications interface 122A. Once access is granted all users are able to interact with one another facilitated through a social network engine interface 118B which may host or integrate a social networking website where users can interact with one another either through an external social networking website or the internal social networking capabilities facilitated through the Global Patient Health Record Timeline Network engine platform 99. The social network engine interface 118B can display various types of data about the users to other users such as profile information, practice affiliation, clinical relationship to the beneficial user 109A, geographical information, and so forth. In addition, all users are capable of sending real time instant messages to other users through the utilization of a Short Messaging Service or (SMS) Interface 125A and a Communications Interface 122A. With these components of the Global Patient Health Record Timeline Network Engine platform 99 the beneficial user or patient 109A is able to communicate with health care provider users and health care provider users 128B are able to instant message other health care provider users 128B related to the treatment, and or health records related to the beneficial user or patient 109A.

A social relationship editor module 116A facilitates editing and/or entering the clinical relationships that the beneficial user or patient 109A has with the various listed healthcare providers listed on the beneficial users or patient's 109A Global Personal Health Record Timeline Network Engine Platform 99. The social relationship editor module 116A can track the acceptance status of one or more clinical relationships between the beneficial user or patient 99 and the healthcare provider users 128B. A social editor display page associated with the social relationship editor module 116A, are displayed graphically on the Global Patient Health Record Timeline Network Engine platform 99.

The social relationship editor module 116A can track data and monitor the one or more clinical relationships that the beneficial user or patient 109A would have with one or more healthcare provider users 128B. Such data would be incorporated into the Global Patient Health Record Timeline for the users such as clinical events and procedures that occurred on a specific day, month, or year to the beneficial user or patient 109A.

A relationship storage module 113B is another component of the Global Patient Health Record Timeline network engine platform 99, that is provided for storing one or more databases including the relationship between the beneficial user or patient 109A and the healthcare provider users 128B. The relationship storage module 113B can utilize any type of storage medium to store the database. For example, the relationship storage module 113B can store the databases in hard drives, (SOAP) Simple object access protocol, (REST) Representational state transfer, Dynamic Random-Access Memory (DRAM), (iSCSI) small computer system interface, Fiber Channel, Network File System (NFS), Common Internet File System (CIFS) along other file based methods of storage and a plurality of other methods of storage. In addition, any storage medium or storage device can be utilized for the storing of information about clinical relationships, profile data, medical record data storage data associated with both the beneficial user 109A and the healthcare provider users 128B.

A social timeline module 115B is also an embodiment associated with the Global Patient Health Record Timeline engine platform 99. The social timeline module 115B utilizes data points from the patient health record data, clinical relationship data, profile data, medical history data, and plurality of external sourced medical data provided by both the beneficial user or patient 109A and the healthcare provider user 128B these data points are then ordered by the times in which the data such as relationships, profiles, and medical procedures occurred. For example beneficial user or patient 109A may indicate that beneficial user or patient 109A had a rhinoplasty on Aug. 23, 2003, and a stage two rhinoplasty on Sep. 12, 2004. The data about the procedures is then ordered in relation to other data provided by the beneficial user or patient 109A and the healthcare provider user 128B, that in this example performed the rhinoplasty, a chronically ordered Global Patient Health Record Timeline is then generated that would organize the two procedures according to a sequential time stamp along with other descriptive data points related to details of procedure outcomes, complications during the procedure, and so forth so that both procedures would be detailed and organized in a sequential and descriptive method related to the procedures that the beneficial user 109A had received in the past.

A display module 112C may be associated with the Global Patient Health Record Timeline Network Engine Platform 99. This display module 112C may generate a display for displaying the Global Patient Health Record Timeline to both beneficial users or patients 109A and healthcare provider users 128B. The Global Patient Health Record Timeline display module 112C would display data items, such as health history events, past procedures, timeframes associated with procedures, medication list, supplemental medical data such as CT and MRI scans, lab results, demographic patient profile data, and a plurality of other data points that would be displayed with the Global Patient Health Record Timeline format related to the Personal Health Record of the beneficial user or patient 109A. The beneficial user or patient 109A grants HIPPA compliant security access to other users, specifically healthcare provider users 128B, and the beneficial user or patient 109A is able to adjust privacy settings to identify other healthcare provider users 128B and other users such as family members that the beneficial user 109A may want to share isolated access to their healthcare record but not their complete health record that is housed within the Global Patient Health Record Timeline Network engine platform 99.

An HL7 interface 110D is also associated with the Global Patient Health Record Timeline Network engine platform 99. This HL7 interface module 110D would facilitates the standardization for interchange of data between different records systems and practice management systems from external sources with the Global Patient Health Record Timeline Network Engine platform 99. For example this HL7 interface 110D would connect or allow for the transfer of data from an external source such as a Hospital or Outpatient Facility 129B with the Global Patient Health Record Timeline data engine 99. If healthcare provider user 128B needed data points and procedural notes on the rhinoplasty that beneficial user or patient 109A had on Aug. 23 2003 and again on Sep. 12 2004, through the HL7 interface 110D the Hospital and/or Outpatient Facility 129B could send these data points via the Global Patient Health Record Timeline engine 99 of the Beneficial user or patient 109A to the requesting healthcare provider user 128B which would have access to the chronological time stamped ordered data points within the Global Patient Health Record Timeline.

An (DICOM) Digital Imaging and Communications in Medicine interface module 111E is also associated with the Global Patient Health Record Timeline engine 99. The DICOM interface also allows for standardized handling, storing, displaying, printing, and transmitting data points related to medical imaging. This interface would allow the sharing, storage, retrieval, and display of such medical imaging studies as a CT scan, MRI scan, Digital X-ray scan and a host of other medical imaging data points within the Global Patient Health Record Timeline Network engine platform 99. The DICOM interface for example would facilitate the integration and sharing of CT scans related to beneficial user 109A between the requesting healthcare provider user 128B and the Hospital and/or Outpatient Facility 129B, which originally performed the diagnostic CT scan on the beneficial user 109A. These medical images ordered from healthcare provider 128B would be integrated into the Global Patient Health Record Timeline Network engine platform 99 related to the beneficial user 109A in a time stamped and chronological ordered format.

A Radio Frequency Identification (RFID) module interface 114A is also associated with the Global Patient Health Record Timeline Network engine platform 99. The Radio Frequency Identification (RFID) module interface 114A utilizes a wireless non-contact system that uses radio-frequency electromagnetic fields to transfer patient data from an RFID enabled article of manufacture to the cloud or web-based Global Patient Health Record Timeline engine, and vice versa for the purposes of making the information housed in the Global Patient Health Record Timeline more portable among various parties that have been granted “HIPPA” compliant security access from the beneficial user or patient 109A. For example The RFID module interface 114A could be utilized in the following manner, the healthcare provider giving an RFID enabled article of manufacture or device to the beneficial user or patient 109A or patient purchasing the RFID enabled device from a manufacturing vendor, that may also Bluetooth Low energy (BLE) enabled, to upload or download healthcare information or data such as results of a physical exam or blood work that healthcare provider user 129A just performed could be uploaded via hardware transceiver and (RIFD) reader to the device or article of manufacture that is in the possession of the beneficial user 109A. The beneficial user 109A in turn can later upload the information given by healthcare provider user 109A to the cloud or web-based Global Patient Health Record Timeline and access the same information or edit the same such information by accessing the cloud or web-based Global Patient Health Record Timeline via HIPPA complaint log-in. This new data, which reflects in this example a physical and/or accompanying blood work, could be in turn be accessed or downloaded if the beneficial user or patient 109 is admitted to the Hospital and Hospital Healthcare providers associated with Hospital Facility 129B needed to access this patient history data, assuming that the beneficial user or patient 109A has given adequate access to the Hospital Facility 129B to access their Patient Health Record Timeline via direct log-in or by scanning an RFID enabled, and in some cases both RFID and Bluetooth Low Energy (BLE) enabled articles of manufacture are to interact and transfer to the Global Patient Health Record Timeline engine 99. As a result there is a connectivity and portability of healthcare records that is created and integrated into the Global Patient Health Record Timeline engine 99 with the integration of an Radiofrequency Identification or RFID module interface 114A either by itself or in combination with a plurality of methods storage, and transmittal such as Bluetooth Low Energy or BLE technology.

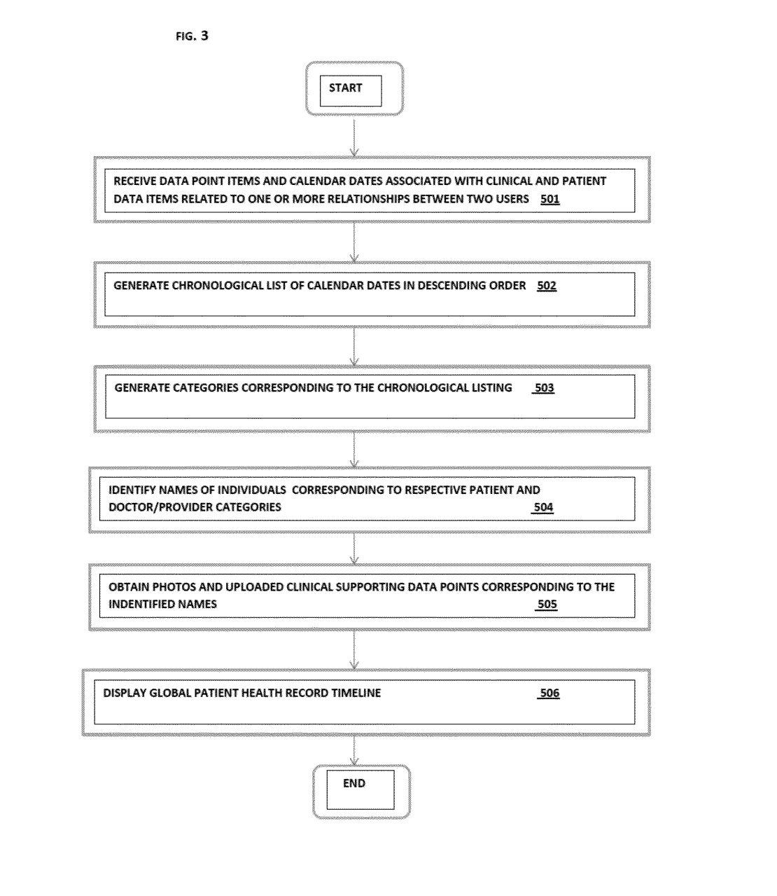

FIG. 3. Is a flow diagram of an exemplary process for ordering data for a Global Patient Health Record Timeline. At step 501, patient health record data items and calendar dates associated with the data items related to a beneficial user or patient for one or more relationships between at least two users are received. The beneficial user or patient 109A and healthcare provider users 128B can all provide data items, such as patient profile or demographic information, procedural events along with outcomes, medications, allergies, labs along with other supplemental medical data, and a plurality of other data points that are organized in the timeline to describe in detail the events and various current and past interactions between the beneficial user or patient 109A and the healthcare provider users 128B.

At step 502, a chronological list of calendar dates in descending order is generated. For example, the social timeline module 115B may access data points integrated from the HL7 interface module 110D, the DICOM interface module 111E, along with and in combination with, the relationship storage module 113B to generate the chronological list.

The chronological list may include all of the patient health record data about the clinical relationships and procedural events along with other health record data points, either provided by the healthcare provider users 128B or the beneficial user or patient 109A for whom the Global Patient Health Record is generated. It also shows the clinical relationships and procedural events that link the beneficial user or patient 109A to a variety of current and former healthcare provider users 128B related to a specific calendar date and timestamp.

At step 503, categories corresponding to the chronological listing are generated. As discussed herein, the chronological listing may be generated from all of the timestamp and timeframe data associated with the clinical relationships and stored medical record data points. The chronological listing may then be divided according to categories, such Primary care provider, sub specialist provider, Groups, Communities, Lab results, mid-level providers such as advanced nurse practitioners, recent procedures, inbox messages, planned procedures, My Medical Wallet (co-pay and patient balance information), medical images, nutrition suggestions, drug allergies, health applications, family circle i.e. all family members granted limited access to certain parts of the personal healthcare record from the beneficial user or patient, current providers group, former providers group, and a plurality of other categories.

At step 504, the names of individuals and relevant medical records data corresponding to the categories are identified. As shown in FIG. 6, the Global Patient Health Record Timeline may display the names of individuals such as the beneficial user or patient 109A and a variety and plurality of healthcare providers 128B that have some clinical connection or have rendered or are currently rendering treatment to the beneficial user or Patient 109A. For example, the names of individuals that are healthcare providers for the beneficial user 109A such as the beneficial user or patients Neurologist, Family physician, Rheumatologist, and so forth may would be displayed under the relevant category according to the time identifier (insert numbering for time stamp from sample page here) in which the beneficial user or patient 109A met, or otherwise associated with the individuals and healthcare providers that are listed by category or other identifiers.

At step 505 photos of users and uploaded supporting clinical data points and supplemental graphical information corresponding to the identified names. As discussed herein, the photos may include pictures of each of the plurality of healthcare provider users 129B that have rendered care to the beneficial user or patient 109A or are currently rendering care to the beneficial user or patient 109A. Also represented in step 505 are pictures of the beneficial user or patient 109A. In addition to pictures of both the beneficial user or patient 109A and the various healthcare provider users from which they receive care, uploaded supporting clinical data points and supplemental graphical information such as CT scans, MRIs, Digital Radiographs, Lab Values, Health metrics graphs for specific values, chest X ray, Cone beam CT scans, and a plurality of other supplemental and supporting clinical data are integrated into step 505 and displayed in the Global Patient Health Record Timeline and arranged according to the appropriate timestamp or relevant calendar date.

At step 506, the Global Patient Health Record Timeline is displayed, for example, as presented by the exemplary embodiments displayed (in FIG. 6 the sample page from the GPHRTL) The Global Patient Health Record Time Line can be updated according to new data, reordered data based on new dates or timelines provided relating to when care was rendered to the beneficial user or patient 109A, and so forth. For example, the beneficial user or patient 109A may add the healthcare provider 109AC, or the patients rheumatologist, into the category of Sub-specialist providers category. The healthcare provider 109AC may then be added to the Global Patient Health Record Timeline according to the dates provided by primarily the beneficial user or patient 109A, or once added by the beneficial user 109A, the healthcare provider 109AC can also add dates correlating to when treatment was rendered and the dates that correlate to uploaded supplemental medical data. The healthcare provider 109AC may be a new healthcare provider for the beneficial user or patient 109A that the beneficial user has just met or the healthcare provider 109AC may be a provider that has rendered care to the beneficial user or patient 109A in the past and has know previously, but with whom the beneficial user or patient 109A has added as a new clinical relationship within the Global Patient Health Record Timeline.

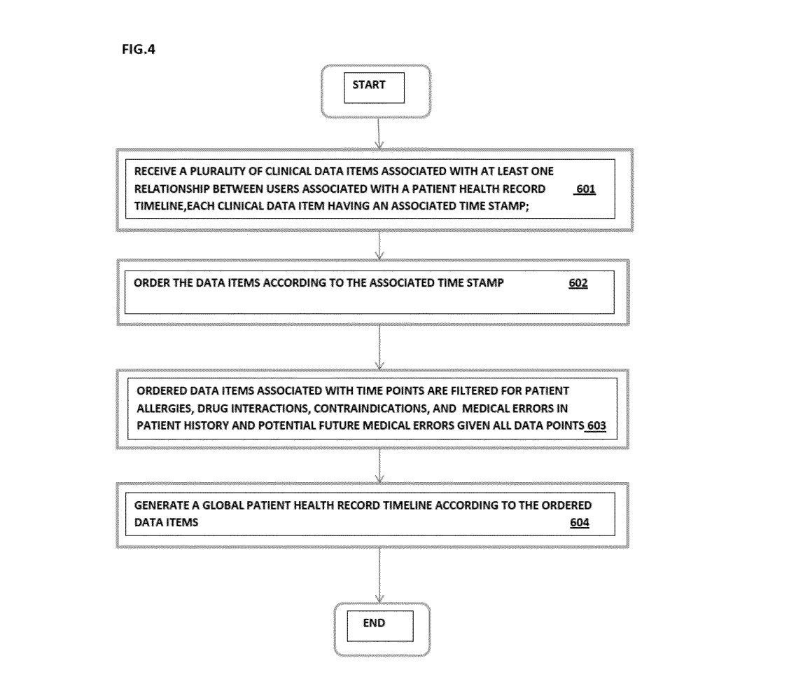

FIG. 4. is a flow diagram of an exemplary process for generating a Global Patient Health Record Time Line. At step 601, a plurality of health record data items associated with at least one relationship between the beneficial user or patient 109A and an individual healthcare provider or multiple healthcare providers that have provided care for the beneficial user 109A currently or have rendered treatment to the beneficial user in the past. For example, the beneficial user or patient 109A can provide clinical events, planned procedures, past procedures, and times associated with the events about a relationship between the beneficial user or patient 109A and individual healthcare providers and/or groups of healthcare providers via the relationship editor module found within the Global Patient Health Record Time line network engine platform 99. Both the beneficial user or patient 109A and individual healthcare providers and/or groups of healthcare providers also can provide any type of data items about the clinical relationship involving the beneficial user or patient 109A, events associated with the relationship, a timestamp or timeframe associated with the relationship and/or events, various special planned procedures associated with a timestamp or timeframe, and so forth.

At step 602, the data items are ordered according to the associated time. As presented herein, the data provided by the beneficial user or patient 109A may be ordered to generate a chronological listing. For example, the data about the beneficial user or patient 109A's relationship with healthcare provider 128BC and the healthcare provider user 129BD may be compared and listed according to dates associated with the relationships with the healthcare provider user 128BC and the healthcare provider user 129BD. If healthcare provider user 129BD and healthcare provide user 129BC are in different categories, such as the healthcare provider user 129BD is the Urologist that has been assigned to the beneficial user or patient 109A, while healthcare provider user 129BC is the rheumatologist assigned to the beneficial user or patient 109A, different chronological listings may be generated for each of these healthcare provider users. The health care record data may also be ordered according to one chronological listing that indicates the timeframes of all of the various relationships.

Step 603, Ordered data items associated with time points are filtered for patient allergies, drug interactions, contraindications, and medical errors the patient's history and the potential for future medical errors given all data points. These data points are filtered through an algorithm data sequence that will occur within the Application Programming (API) Interface module 126A within the Global Patient Health Record network engine platform 99. For example, the beneficial user or patient 109A may have a drug allergy to sulfa based medications, both the beneficial user or patient 109A and the healthcare provider user 128B, as well as other healthcare providers that well render treatment to the patient, can note this allergy to sulfa based medications so that if a new provider such as healthcare provider user 149AC had a planned procedure with the beneficial user or patient 109A provider user 149C would know not to proscribe any sulfa based medications post operatively for the beneficial user or patient 109A by referencing the beneficial users the patients allergies category within the beneficial users Global Patient Health Record Timeline once generated at the end of step 604.

Step 604, the generation of a Global Patient Health Record Time Line according to the ordered data items of the previous steps. The Global Patient Health Record Time Line may include a listing by increment of time, such as year, month, day, and so forth, of clinical relationships of the beneficial user or patient 109A with a plurality of healthcare provider users that provide healthcare to the beneficial user or patient 109A. As discussed herein, the Global Patient Health Record Timeline may include all of the relationships, relationships according to categories, and/or individual relationships. These time stamps or chronological listings are also related to events, current medical procedures and related procedures that have occurred in the past.

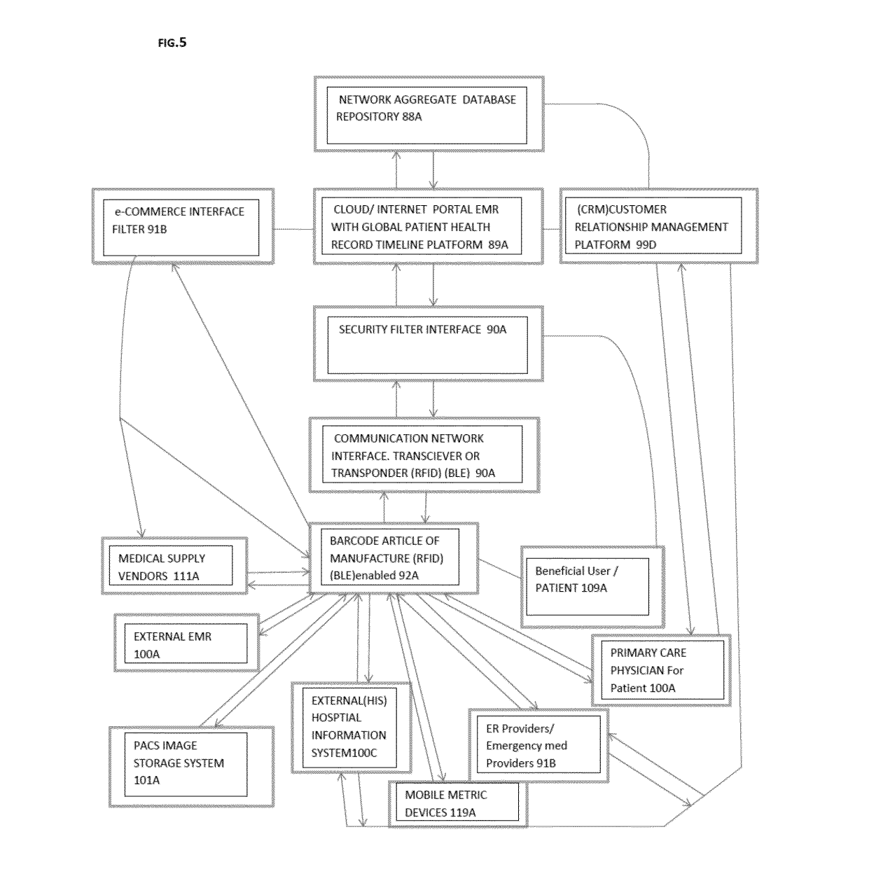

FIG. 5 illustrates an exemplary embodiments of an ERP/EMRSE or ERP/EMR Software Environment or (Enterprise Resource Planning Electronic Medical Records Software Environment) that includes the Global Patient Health Record Timeline as a central component of the environment. The principle components and interfaces of the ERP/EMRSE or ERP/EMR Software Environment or (Enterprise Resource Planning Electronic Medical Records Software Environment) are; Network Aggregate Database Repository 88A the key component functions as a clearing house where data is cleared, transformed, cataloged and made available for use by many stakeholders within the ERP/EMRSE total environment or localized medical data ecosystem for data mining, online analytical processing, and plurality of various other synchronized functions. For example, The Network Aggregate Database Repository 88A would interface with the e-Commerce Interface filter 91B to efficiently route and catalog varies processed payment orders that have been made by beneficial user or patient 109A this stored information could be accessed by the attending healthcare provider 100A, who delivered the services to beneficial user or patient 109A, for accounting reconciliation of provider 100A outstanding accounts receivables derived from account reconciliation software found within a Customer Relationship Management (CRM) Platform and Practice Management (PM) Platform 99D within the ERP/EMRSE total environment or localized medical data ecosystem.

An eCommerce Interface filter 91B this component or embodiment within the Enterprise Resource Planning Electronic Medical Records Software Environment (ERP/EMRSE) or localized medical data ecosystem, facilitates patients in paying outstanding co-payments, unpaid balances, and pay for future planned procedures that will be performed by healthcare providers that are members or users of the ERP/EMRSE or localized medical data ecosystem. This platform allows patients to accumulate categorized lists of invoicing data items that can be paid for through the platform. These categorized lists of data items that are related to the invoicing of patients related and rendered treatment are dynamically generated by the ERM/EMRSE CRM or eCommerce Interface filter 91B software based on information saved and housed within the Network Aggregate Database Repository 88A.

A cloud or internet based dual portal Electronic Medical Records (EMR) platform with Global Personal Health Record Timeline Personal Health Record Interface (PHR) 89A is a key embodiment of the ERP/EMRSE or (Enterprise Resource Planning Electronic Medical Record Software Environment). This embodiment facilitates the storage and organization of all medical records, third-party medical insurance payor information for services rendered, supplement lab results, supplement diagnostic imaging test results, biographical information for patients treated, biographical information of the attending or treating healthcare provider, storage of all dictation notes, storage of all manually entered notes, and a plurality other medical data related to the beneficial user or patient 109A. Most importantly this embodiment houses the Global Patient Health Record Timeline Network engine platform 99, which facilities the chronological storage of the medical data in the cloud or web based dual portal EMR and facilitates the transmittal of information through Radio Frequency Identification (RFID) technology and/or Bluetooth Low Energy (BLE) technology between users and the Cloud or internet based dual portal EMR with Global Patient Health Record Timeline interface 89A.

A Barcode Article of Manufacture (RFID) or (BLE) enabled Interface 92A is a key embodiment within the ERP/EMRSE localized medical data ecosystem, which facilities the transfer, transmittal, and cataloging of the various beneficial users or patient's personal medical records and things such as inventories and medical supplies that are housed within a hospital, medical practice or group practice would all be cataloged and organized within the ERP/EMRSE localized medical data ecosystem. For example, if healthcare provider 100A gave the beneficial user or patient 109A an (RFID) or (BLE) bar encoded article of manufacture 92A the healthcare provider 100A could download immunization records via a transceiver or transponder interface 90A for the beneficial user or patient 109A onto the patients (RFID) (BLE) article of manufacture 92A which could be accessed later by the patient once the patient placed the article of manufacture near a transceiver or transponder interface 90A that would facilitate the data or information points to be uploaded to the Cloud or internet based dual portal EMR with Global Patient Health Record Timeline interface 89A. Once data points are uploaded the beneficial user or patient 109A can access and edit information or just review information.

A security filter interface 90A would function to provide HIPPA compliant security features to the ERP/EMRSE localized medical data ecosystem. It would function to protect the integrity of patient health records, healthcare provider records of rendered treatment, e Commerce transactions, and a plurality of other security functions. Some of the security features would secured encryption, Wired Equivalent Privacy (WEP), (WPA2) Wi Fi protected Access, (WIPS) wireless intrusion prevention systems, and a plurality of other security measures that will secure all components of the ERP/EMRSE localized medical data ecosystem.

A (CRM) Customer Relationship Management and Practice Management (PM) Platform 99D is a key embodiment with the ERP/EMRSE localized medical data ecosystem. This embodiment functions to organize, automate, and synchronize medical practice and business process activities such as invoicing of patients, patient procedure time block data mining for patient schedule flow management, back office marketing information, report generation for the overall financial performance of a medical or dental solo-practice, group practice, outpatient medical facility or hospital. For example Primary Care Provider 100A wants to know his ROI or Return On Investment for a direct mailer campaign he implemented a year ago and compare it to past direct mail campaigns, so the provider can run a series of reports directly from the (CRM) (PM) Platform 99D and would give a comparative ROI for all zip codes within a 20 mile radius of his primary care practice location. As a result the Primary Care Provider 100A would know from this report which zip code brings him the most patients, which can help the provider to focus on those zip codes which has the highest ROI per dollar expended on the direct mail out campaigns. Another example could be a Primary Care Provider 100A wants to compare over the last 12 months which quarters were the most profitable for him and what were the key services, third-party insurance payor mix, provider production numbers, and patient numbers during those fiscal quarters. So Primary Care Provider 100A can run a report through the CRM/PM platform within the ERP/EMRSE localized medical data ecosystem and get analysis and results with procedure breakdown, third party medical insurance reimbursement, provider production as well as collection numbers, and patient co payments during these quarters. The final generated report will help Primary Care Provider 100A and his staff to reproduce the successful results of their most successful quarters and also improve on those successful results through a variety and plurality of financial reports generated from the Customer Relationship Management (CRM) and Practice Management (PM) Platform 99D within the ERP/EMRSE localized medical data ecosystem.

It should be noted that while various embodiments have been described above, it should be understood that they have been presented by way of example only, and not limitation. As such the aforementioned is a limited subset for exemplary purposes only, and does not define the full scope nor all the functions of all the embodiments of the aforementioned subject matter. Thus, the breadth and scope of a preferred embodiment should not be limited by any of the above-described exemplary embodiments.

What is claimed is:

1. A computer-implemented method comprising: maintaining in a computer system a plurality of relationships among users in a social networking system that interfaces with data from an Electronic Medical Record (EMR) system, Health Information Exchange (HIE) system, Personal Health Record (PHR) system, Picture Archiving and Communication System (PACS), Hospital information Systems (HIS), Laboratory Information Systems (LIS), Assigned Healthcare Providers, user health insurance plans, medical and dental providers, external data points from a plurality of other data sources related to health care records and wellness and medical devices of at least one user, each relationship comprising a connection between at least two users of the social networking system; for at least one relationship, receiving one or more clinical encounter data points, medical history data points and clinical relationship details from at least one user in the relationship, wherein at least one of the relationship details are received via a relationship inquiry and “HIPAA” (Health Insurance Portability and Accountability Act) compliant security clearance user interface based on secured authorization from the first individual or beneficial user, which grants access to full data points to the respective one or more users of the Global Patient Health Record Timeline (GPHRT) or information network; associating the received relationship details with one or more calendar dates associated with the one or more relationship details; generating a global personal health record timeline comprising a chronological representation of one or more of the relationship details and their associated calendar dates, the relationship details comprised of events or other data pertaining to the clinical relationship, clinical history outcomes, planned medical treatment and all other supporting medical history and treatment plan data related to users in the relationship and shared in common during a set of time periods; and sending the Global Patient Health Record Timeline of the relationships for display in a graphical user interface and supported by a storage network that is a cloud or internet based network storage system. These aforementioned embodiments would further be integrated into an ERP/EMRSE or Enterprise Resource Planning Electronic Medical Records Software Environment which would interconnect an Network Aggregate Database Repository with a Cloud or web-based Repository server, security interface, customer resource management platform (CRM), practice management platform (PM), e-commerce interface, “HIPPA” compliant Security filter and Radiofrequency Identification (RFID) Technology and Bluetooth Low Energy (BLE) technology interface to connect beneficial users or patient to healthcare prude, users and these users to external sources of medical and health records data such as external Electronic Medical Record (EMR) system, Health Information Exchange (HIE) system, Personal Health Record (PHR) system, Picture Archiving and Communication System (PACS), Hospital Information Systems (HIS), Laboratory Information Systems (LIS), along with other Assigned Healthcare Providers. In addition to connectivity between beneficial users or patients and healthcare provider users, the ERP/EMRSE will provide increased efficiencies and interconnectivity between individual healthcare providers, healthcare providers within a healthcare organization, hospitals and outpatient facilities to connect with third-party medical vendors and service companies along with interconnectivity between various healthcare entities within the ERP/EMRSE network.

2. The method of claim 1, wherein one or more of the received relationship details comprises a durational time period of the relationship and a category of the relationship related to the medical care of at least one of the use within the relationship.

3. The method of claim 1, wherein access to the Global Personal Health Record Timeline network requires HIPAA or “Health Insurance Portability and accountability Act” compliant explicit authorization through a security clearance user interface from the first individual or clinical beneficiary of the stored health record data points, to all other users and participant users of data originating from the beneficiary user's personal health record timeline network.

4. The method of claim 1, further comprising: enabling authorized participant users connected in the relationships displayed on the global personal health record timeline to edit the personal health record timeline social network.

5. The method of claim 1, further comprising: generating both clinical narrative and specific care provider notes for both patient users and medical team provider users based on the Global Patient Health Record Timeline.

6. The method of claim 1, wherein the Global Patient Health Record Timeline further comprises one or mare events related to at least one of the clinical relationships in the Global Patient Health Record Timeline.

7. The method of claim 1, wherein the beneficial user or patient can through a plurality of articles of manufacture that are enabled with Bluetooth Low Energy Technology (BLE) take certain specific health metrics and tests on themselves and these said metrics would then be transferred via Radio Frequency identification Technology (RFID) and/or in combination with Bluetooth Low Energy (BLE) technology to the Global Patient Health Record Social Timeline for integration of the metrics into the patient's or Beneficial users health record timeline. Such limited examples of a variety of metrics that could be taken would be Heart Rate, Blood Pressure, Internal Normalizing Rate (INR), oxygen levels and variety of other metrics that a patient could check on their own utilizing a variety of articles of manufacture that is enabled with Bluetooth Low Energy (BLE) technology utilized and specific to measuring specific medical metrics and healthcare benchmarks that would interface and communicate with the Global Patient Health Record Timeline cloud and/or internet supported platform.

8. The method of claim 1, wherein the beneficial user or patient is given an (RFID) or Radio Frequency identification barcode enabled device (i.e. key chain, badge, card, necklace, bracelet, cellular phone, tablet, and/or any plurality of alternate devices) selected from a plurality of alternative Auto-ID technology enabled articles of manufacture from beneficial user's health care provider and/or other providers that have contact with the beneficial user or patient. This barcode enabled device that is given to the patient may also contain Bluetooth Low Energy (BLE) Technology. With this barcode enable article of manufacture, said beneficial user, utilizing Radio Frequency identification (RFID) technology, Bluetooth Low Energy (BLE) technology and a plurality other identification technologies, can receive and send or transmit patient records from beneficial users health care provider via transceiver hardware technology. Once information is loaded onto article of manufacture both the beneficial user and beneficial user's healthcare provider can retrieve and transmit the said patient health records to a cloud or internet portal based storage network through both parties gaining access via a security filter with “HIPPA” compliant security filters, information stored on said cloud or internet portal solution is housed within the Global Patient Record Timeline platform and storage network of method of claim 1. Other users and restricted vendors (i.e., hotels, cruise lines, airlines along with a plurality other restricted vendors that utilize it help travelers in cases of emergency where a guest needs immediate medical care from health care providers), and other ancillary mid-level health care providers can gain access to said information only after beneficial user or patient has authorized access to their health records and has allowed them the ability to upload information to the patient's Global Patient Health Record Timeline via RFID technology utilizing transceiver hardware along with alternate methods and technologies of storage, transmittal, and integration. All uploaded information will be stored via a cloud based storage patient record network that will be housed in an aggregate network depositary module that can be accessed only by those users that have been granted access or credentials by the beneficial user, patient, access the Global Patient Health Record Timeline via the “HIPPA” or “Health insurance Portability and accountability Act” compliant and encrypted security portal. The said information that is stored in the cloud or internet based aggregate network depositary can be accessed and loaded onto a plurality of RFID enabled articles of manufacture and other alternative devices of manufacture that function to receive, catalog, and transmit data stored on the Global Patient Health Record Timeline platform along with patient health record information that has been edited, updated or revised after initial entry into the Global Patient Health Record Timeline.

9. The method of claim 1, wherein the Global Personal Health Record Timeline further comprises photos of one or more of both the patient users and medical team provider users connected in at least one of the relationships in the global personal health record timeline.

10. The method of claim 1, wherein the ERP/EMRSE allows for interconnectivity between individual healthcare providers, healthcare providers within a healthcare organization hospitals, outpatient medical practices, dental practices, and outpatient facilities to connect with third-party medical vendors and service companies. Furthermore, enables beneficial users or patients to complete e-commerce and third party insurance charge capture payment transactions related to their balances, real time co-payments and service fees to in healthcare providers via Radiofrequency identification (RFID) technology and, or Bluetooth Low Energy (BLE) technology enabled articles of manufacture connected to the cloud or web-based portal or the beneficial user can process these same said transactions by accessing the cloud or web based portal directly via the “HIPPA” or “Health insurance Portability and accountability Act” compliant log-in to complete these same transactions that will remit payment to the respective healthcare provider user of the Global Patient Health Record timeline platform as well as any other component of the ERP/EMRSE network or Enterprise Resource Planning Electronic Medical Records Software Environment.

11. A system comprising: a processor; a non-transitory computer readable storage medium, the storage medium storing; a social relationship editor module configured to maintain in a computer system a plurality of relationships among users in a social networking system, each relationship comprising a connection between at least two users of the social networking system; a communications interface configured to, integrate data points that originate from external data sources such as a Health Information Exchange System (HIE), Electronic Medical Records System (EMR), an External Personal Health Record (PHR), Picture Archiving and Communication System (PACS), Hospital Information Systems Laboratory Information Systems (LIS), Assigned Healthcare Providers, External Social Networking Systems and other external data point sources related to beneficial user's personal health record that integrate into the global personal health record timeline network; a communications interface configured to, for at least one relationship, receive one or more relationship details from at least one of the users in the relationship, wherein at least one of the relationship details are received via a relationship inquiry user interface and further configured to associate the received relationship details and correlated clinical event details with one or more calendar dates associated with the one or more relationship details; a social timeline module configured to generate a global personal health record timeline comprising a chronological representation of one or more of the relationship details and their associated calendar dates, the relationship details and supporting clinical data comprising events or other data pertaining to the relationship that the users in the relationship had in common during a set of time periods; and a display configured to send the social timeline of the relationships for display in a graphical user interface. A security clearance user interface which comprises hardware Radiofrequency Identification (RFID) transponders, readers and supplemental data acquisition interface units integrated and filtered with “HIPPA” or “Health Insurance Portability and accountability Act” compliant explicit authorization encrypted password related to the software wherein data is transferred from global personal health record timeline social network to a plurality of articles of manufacture that contain Radio Frequency identification (RFID), Bluetooth Low Energy (BLE) technology, and a plurality of other means of data exchange between the global personal health record timeline and a plurality of external storage devices and articles of manufacture. Further, where the security clearance user interface for the global personal health record timeline software is filtered with “HIPPA” or “Health Insurance Portability and Accountability Act” compliant explicit authorization encrypted password filters to give at least one or more users access to the global personal health record timeline software and database cloud network.

12. The method of claim 8, further comprising: enabling authorized participant users to receive electronic message notifications related to future chronologically planned events related to the delivery of heath care for one or more users. Wherein the electronic message notification and electronic alerts originating from the global personal health record network would be transmitted to a plurality of articles of manufacture that would receive the said signal and display the transmitted data on user chosen articles of manufacture that contain Radio Frequency identification (RFID) Technology with the inclusion of a combination with a plurality of other data acquisition, transmittal and storage technologies and methods such as Bluetooth Low Energy (BLE) Technology.

13. The method of claim 8, further comprising: authorized participant users to receive electronic alerts and message notifications to a plurality of end user articles of manufacture that contain a variety and plurality of data acquisition, transmittal and storage methods and technologies.

14. The method of claim 8, wherein global patient health record timeline health record data related to health record information related to network users is transmitted from a plurality of external health record storage sources and integrated within the global personal health record social timeline and further transmitted from the global personal health record social timeline platform through the utilization of Radio Frequency Identification (RFID) transponders, readers, and a plurality of other data acquisition and data transmission articles of manufacture, one such example being Bluetooth Low Energy (BLE) technology.

15. The method of claim 8, wherein the global patient health record timeline network can interface and exchange data with external social network systems and data bases only with the explicit authorization of the users in the relationships found within the global patient health record timeline.

16. The method of claim 8, wherein the social timeline further comprises one or more events related to at least one of the relationships in the global personal health record timeline social network.

17. A computer program product comprising a computer-readable medium containing computer program code for: maintaining in a computer system a plurality of relationships among users in a social networking system and integrated with external sources of health record and health history data found in such external sources as Health Information Exchange (HIE) System, Electronic Medical Records (EMR) System, Personal Health Records (PHR) systems, Picture Archiving and Communication System (PACS), Assigned Healthcare Providers, Hospital Information Systems (HIS), Laboratory Information Systems (LIS), and a plurality of other external health record data storage source points integrated into a social network system; for at least one relationship, receiving one or more relationship details from at least one of the users in the relationship, wherein at least one of the relationship details are received via a relationship inquiry user interface and authorized access to relationship details granted through a “HIPPA” or “Health insurance Portability and Accountability Act” compliant security clearance user interface; associating the received relationship details with one or more calendar dates associated with the one or more relationship details; generating a social timeline comprising a chronological representation of one or more of the relationship details, external data points that are integrated into the social timeline from a Health Information Exchange System (HIE), Electronic Medical Records (EMR) system, Personal Heath Record (PHR) system, Picture Archiving and Communications System (PACS), Hospital Information Systems (HIS), Laboratory Information Systems (LIS), Assigned Healthcare Providers, External social networking systems, along with other third-party data sources relating to at least one user and relationship details and their associated calendar dates, the relationship details comprising clinical events, medical history, provider recommendations, customized daily health plans originating from the medical provider user and utilized by the patient user in the relationship or any other supplemental data pertaining to the relationship that the users in the relationship had in common during a set of time periods; and sending the personal health record social timeline of the relationships for display in a graphical user interface. Further, a system giving the user or users the ability to acquire, transmit, and store data from the Global Personal Health Record Timeline to a plurality of external articles of manufacture that utilize Radio Frequency Identification (RFID) technology or other alternate methods of data point acquisition, transmittal and storage of data that originate from the Global Personal Health Record Timeline and are transmitted to an external article of manufacture.

18. The computer program product of claim 14, wherein one or more of the relationship details comprises a durational time period of the relationship and a category and designation of the healthcare provider users in relation to the patient users in the relationship.

19. The computer program product of claim 14, Wherein the code for displaying is configured to display the Global Personal Health Record Timeline according to privacy settings selected by at least one of the users in at least one of the relationships in the Global Personal Health Record Timeline.

20. The computer program product of claim 14, the computer-readable storage medium further containing computer program code for: enabling the users connected in the relationships displayed on the patient health record social timeline to edit the social timeline; further containing computer program code for: integrating supplement external third party medical data points related to the beneficial patient user. Such data would be integrated from external sources such as Health Information Exchange (HIE) systems, Electronic Medical Records systems, Personal Health Records (PHR) systems, Picture Archiving and Communications System (PACS), Assigned Healthcare Providers, Hospital Information Systems (HIS), Laboratory Information Systems (LIS), and a plurality of other external sources of data points that can be integrated into the Global Personal Health Record Timeline platform.

21. The computer program product of claim 14, the computer-readable storage medium further containing computer program code for: filtering and processing through algorithm the potential and statistical probability that a medical error can occur during or after a planned procedural event or the possibility that a medical error would occur based on any indicated contraindicated drug, allergic, or other reactions that would effect the patient user in at least one relationship represented in the Global Personal Health Record Timeline.

22. The computer program product of claim 14, the computer-readable storage medium further containing computer program code for: generating clinical notes, archiving of voice dictation files, storage of plurality of radiographic image modalities, and clinical narratives for the users based on the Global Personal Health Record Timeline along with a plurality of functions that are supported by the computer program code.

23. The computer program product of claim 14, the computer-readable storage medium further containing computer program code for: generating stories, personal narratives, and personal reminder notes for the patient-users based on the Global Personal Health Record Timeline.

24. The computer program product of claim 14, wherein the timeline further comprises photos, radiographic, lab results, and other supporting clinical data points related to one or more of the users connected in at least one of the relationships in the Global Personal Health Record Timeline.

25. The computer program product of claim 14, Wherein the timeline further comprises photos of one or more of the users connected in at least one of the relationships in the Global Personal Health Record Timeline.

26. The computer program product of claim 14, wherein the Global Personal Health Record Timeline further comprises one or more events related to at least one of the relationships in the Global Personal Health Record Timeline.

27. The computer program product of claim 14, wherein the Global Personal Health Record Timeline further is enabled to originate electronic mail notifications and specialized alert notifications to at least one user in at least one of the relationships in the Global Personal Health Record Timeline.

28. The computer program product of claim 14, wherein the Global Personal Health Record Timeline is further enabled to process e-commerce transactions related to the beneficial user or patients outstanding balance or co-payments and purchases, and service fee payments through the cloud or web-based Repository linked to the Global Personal Health Record Timeline platform or any other component of the ERP/EMRSE or Enterprise Resource Planning Electronic Medical Records Software Environment via Radiofrequency Identification (RFID) Technology or Bluetooth Low Energy (BLE) technology. This allows the beneficial user or patient to remit payments to the healthcare provider who rendered services to the beneficial user or patient who initiated the payment in exchange for healthcare services rendered by the beneficial users healthcare provider.
